(19) United States
(12) Patent Application Publication
(10) Pub. No.: US 2015/0081328 A1
(43) Pub. Date: Mar. 19, 2015

(54) SYSTEM FOR HOSPITAL ADAPTIVE READMISSION PREDICTION AND MANAGEMENT

(71) Applicant: University of Pittsburgh - Of the Commonwealth System of Higher Education, Pittsburgh, PA (US)

(72) Inventor: FU CHIANG TSUI, Pittsburgh, PA (US)

(73) Assignee: University of Pittsburgh - Of the Commonwealth System of Higher Education, Pittsburgh, PA (US)

(21) Appl. No.: 14/490,139

(22) Filed: Sep. 18, 2014

Related U.S. Application Data
(60) Provisional application No. 61/879,401, filed on Sep. 18, 2013.

(51) Int. Cl. G06F 19/00

(52) U.S. Cl. CPC G06F 19/3431; G06F 19/363
USPC 705/2

(57) ABSTRACT

A method of determining a probability of readmission of a patient includes receiving patient data from a plurality of information sources; calculating the probability of readmission of the patient based on the patient data and an adaptive readmission risk model; and providing the probability of readmission of the patient to a medical provider.

### CROSS-REFERENCE TO RELATED APPLICATIONS

This application claims priority under 35 U.S.C. §119(c) from U.S. provisional patent application No. 61/879,401, entitled “Automatic Adaptive Readmission Prediction System” and filed on Sep. 18, 2013, the contents of which are incorporated herein by reference.

### BACKGROUND OF THE INVENTION

1. Field of the Invention

The present invention pertains to management of hospital readmissions, and in particular, to a system and method for predicting a probability of a patient being readmitted to a hospital following a patient hospital stay.

2. Description of the Related Art

The Centers of Medicare and Medicaid Services (CMS) have begun to penalize hospitals with excess readmissions by reducing reimbursement payment since 2013. Hospitals can lose up to 1% of total Medicare inpatient revenue in 2013; 2,200+hospitals are expected to be penalized, each of which could lose about $125,000 on average, with the total loss of $280 million. The reduction penalty will increase to 2% in 2014 and 3% in 2015. Currently, most hospitals rely on manual processes for readmission reduction and do not have a clear target group of high-risk readmitted patients. There is thus room for improvement in this area.

### SUMMARY OF THE INVENTION

In one embodiment, a method for determining a probability of readmission of a patient includes receiving patient data from a plurality of information sources; calculating the probability of readmission of the patient based on the patient data and an adaptive readmission risk model; and providing the probability of readmission of the patient to a medical provider.

In another embodiment, a system for determining a probability of readmission of a patient includes an interface structured to receive patient data from a plurality of information sources; and an adaptive modeling module structured to calculate the probability of readmission of the patient based on the patient data and an adaptive readmission risk model, wherein the interface is further structured to provide the probability of readmission of the patient to a medical provider.

In still another embodiment, a non-transitory computer readable medium storing one or snore programs, including instructions, which when executed by a computer, causes the computer to perform a method of determining a probability of readmission of a patient. The method includes receiving patient data from a plurality of information sources; calculating the probability of readmission of the patient based on the patient data and an adaptive readmission risk model; and providing the probability of readmission of the patient to a medical provider.

### BRIEF DESCRIPTION OF TUE DRAWINGS

FIG. 1 is a schematic diagram of a system of calculating a probability of readmission of a patient in accordance with an exemplary embodiment of the disclosed concept;

FIG. 2 is an output of the system of FIG. 1 is accordance with an exemplary embodiment of the disclosed concept;

FIG. 3 is a flowchart of a method of calculating a probability of readmission of a patient in accordance with an exemplary embodiment of the disclosed concept;

FIG. 4 is a flowchart of a method of surveying a patient in accordance with an exemplary embodiment of the disclosed concept;

FIG. 5 is a schematic diagram of a computing device in accordance with an exemplary embodiment of the disclosed concept; and

FIG. 6 is another example of an output of the system of FIG. 1 in accordance with an exemplary embodiment of the disclosed concept.

### DETAILED DESCRIPTION OF EXEMPLARY EMBODIMENTS

As employed herein, the term “number” shall mean one or all integer greater than one (i.e., a plurality).

As used herein, the terms “component” and “system” as used in the computer context are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. While certain ways of displaying information to users are shown and described with respect to certain figures or graphs as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject invention. It will be evident, however, that the disclosed concept can be practiced without these specific details without departing from the spirit and scope of this innovation.

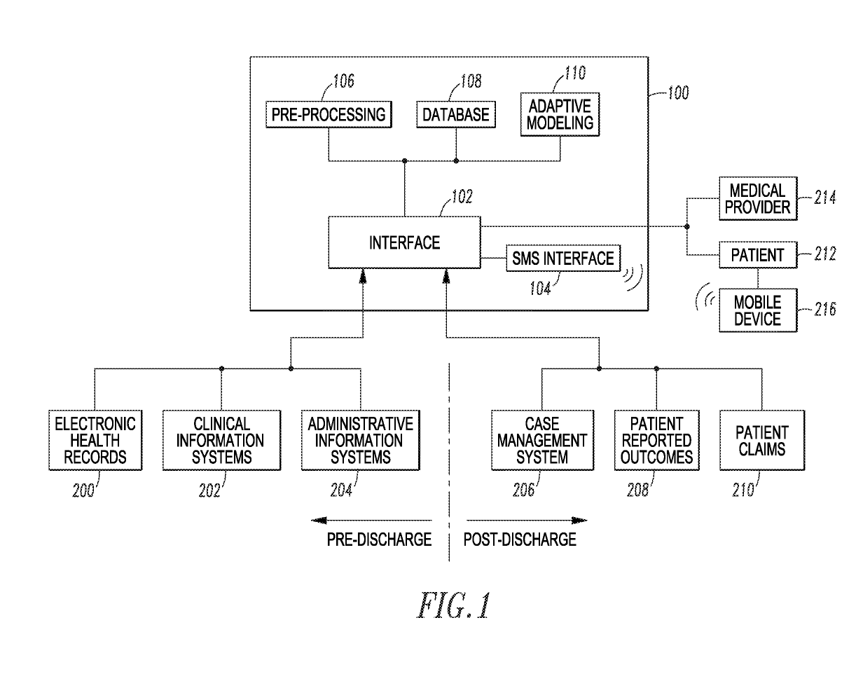

FIG. 1 is a schematic diagram of a system 100 for determining the probability of readmission for a patient. The system 100 includes an interface 102, a short message service (SMS) interface 104, a pre-processing module 106, a database 108, and an adaptive modeling module 110. The system 100 receives patient data from several information sources and uses the patient data and adaptive modeling to calculate and provide the probability of readmission of the patient. An exemplary embodiment of the system 100 will be described in more detail hereinafter.

The interface 102 is structured to receive patient data from information sources. Some examples of information sources include electronic health records systems 200, clinical information systems 202, administrative information systems 204, a case management system 206, patient reported outcomes 208, and patient claims 210.

The electronic health records systems 200 are systems that store patient electronic health records. The electronic health records 200 provide patient data such as patient billing data, demographics, medical charts, laboratory test results medication history etc.

The clinical information systems 202 are, for example, hospital computer silo systems containing clinical or health-related information relevant to healthcare providers in diagnosing treating and monitoring patient care. Laboratory systems, imaging systems (e.g., x-ray, magnetic resonance imaging, computerized tomography scan), medication administration systems, and medical document management systems are examples of clinical information systems 202. The clinical information systems 202 provide patient data such as laboratory results, medical images, patient medications, clinician notes (e.g., discharged summaries, progress notes, operation notes), and nursing documents.

The administrative information systems 204 are, for example, systems used to support hospital operational and financial management. The administrative information systems 204 provide patient data such as patient registration (admissions, discharges, and transfers), patient scheduling, and patient billing.

The case management system 206 is, for example, a software tool which has a graphical user interface allowing healthcare staff such as case managers, clinicians, or nurses to enter or retrieve planning and coordination of healthcare services for achieving the goal of improved patient care. The case management system 206 provides patient data such as a patient care plan, patient interviews and home visit information.

The patient reported outcomes 208 are information reported by patients through different channels such as survey papers, web pages, mobile applications, and mobile text messages. The patient reported outcomes 208 provide patient data such as medication status (taking or not taking prescribed medication) and adverse symptoms (e.g., weight gain, shortness of breath) after hospital discharge.

The patient claims 210 are insurance claims of a patient. The patient claims 210 provide patient data such as prescribed medicine copay at a pharmacy store counter.

The interface 102 is also structured to send or receive patient data from a patient 212 or a medical provider 214. For example and without limitation, the patient 212 may receive reminders from the system 100 or provide answers asked by medical provider 214 or the system 100. The medical provider 214 may include, for example, a physician, a nurse, or a case manager. The medical provider 214 is able to communicate with the system 100 through the interface 102 to review or modify the patient data.

In order to facilitate communication with the various information sources, the patient 212 and the medical provider 214, the interface 102 may include, for example and without limitation, health level 7 (HL7) listeners and/or a web services module. However, the disclosed concept is not limited thereto and it is contemplated that the interface 102 may include any technology suitable to facilitate communication with the various information sources, the patient 212 and the medical provider 214. It is contemplated that the interface 102 may be configured to automatically gather the patient data from the information sources as much as possible.

The patient data includes both pre-discharge data and post-discharge data. The pre-discharge data is data obtained about the patient before the patient is discharged from the hospital. The post-discharge data is data obtained about the patient after the patient is discharged from the hospital. By continuing to monitor patient data after the patient is discharged from the hospital, a patient whose probability of readmission increases due to post-discharge events can be identified and treated.

The pre-processing module 106 is structured to perform pre-processing on at least some of the patient data before it is provided to the adaptive modeling module 110. For example, the pre-processing module 106 may provide a terminology service that maps local hospital terms to standard concept codes such as UMLS, SNOMED, and LOINC. The pre-processing module 106 may also provide an ontology service that creates an ontology hierarchy between different clinical terms to summarize clinical information. The pre-processing module 106 may further provide natural language processing to extract clinical information from free-text data such as progress notes or a discharge summary. While some examples of pre-processing functions have been described, the disclosed concept is not limited thereto. It is contemplated that any suitable pre-processing functions may be included in the pre-processing module 106 without departing from the scope of the disclosed concept.

The database 108 is structured to store data in support of the calculation of the probability of readmission of the patient. For example, the database 108 may store patient data received through interface 102 from the various information sources, the patient 212 and the medical provider 214. The database 108 may also store data in support of the adaptive modeling module 110.

The adaptive modeling module 110 is structured to calculate the probability of readmission of the patient using the patient data and an adaptive readmission risk model processed in an inference engine which may be included in the adaptive modeling module 110. The adaptive modeling module 110 comprises predictive readmission models and an inference engine, The predictive models serve as a knowledge base that can be, but is not limited to, Bayesian networks, artificial neural networks, support vector machines, logistic regression models, and other machine learning models. The inference engine will calculate readmission probability by first assigning the values of the parameters defined in a predictive model retrieved from the database 108. The calculation of the probability of readmission may be event driven, For example, the adaptive modeling module 110 may calculate the probability of readmission in response to an event such as a lab report for a patient being available from a laboratory information system.

The adaptive modeling module 110 also uses machine algorithms to refine the adaptive readmission risk model. Re-training of the adaptive readmission risk model may be manually triggered or it may be automatically triggered based on, for example, performance measurement values falling below predetermined thresholds.

The adaptive modeling module 110 can also use feedback from the medical provider 214 to update the adaptive readmission risk model, For example, the medical provider 214 can view and change patient data such as the status of a patient's symptoms and findings. The updated patient data can then be used to recalculate the probability of readmission of the patient as well as for adapting the adaptive readmission risk model.

When the probability of readmission of the patient has been calculated, the interface 102 provides the probability to the medical provider 214 and/or the patient 212. In addition to the probability, the interface 102 provides explanations for the probability such as explanations for factors that have increased the patient's probability of readmission.

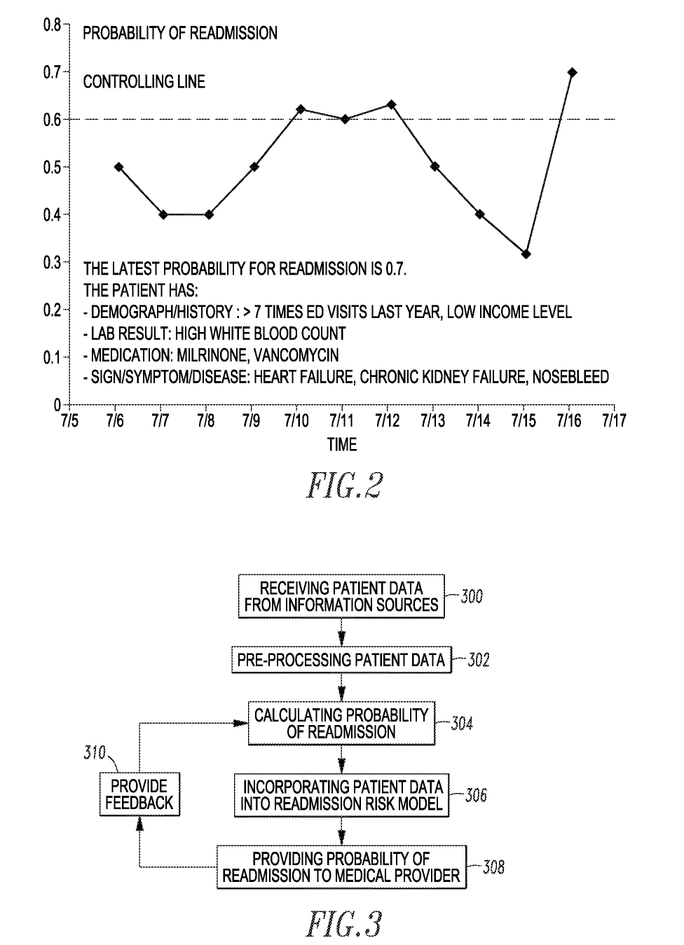

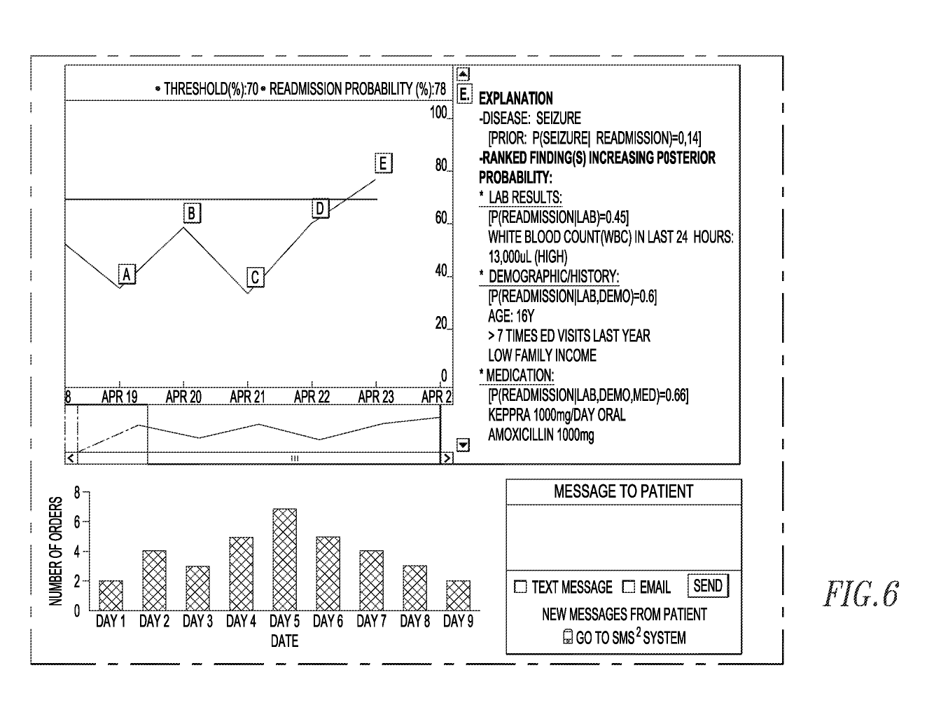

An example screen of the output to the medical provider 214 and/or patient 212 is shown in FIG. 2. Another example screen of the output to the medical provider 214 and/or patient 212 is shown in FIG. 6. The example screen may be viewed by the medical provider 214 and/or patient 212 on any suitable device with a display. It is also contemplated that the output may take any other suitable form such as, without limitation, a print-out. As shown in FIG. 2 or 6, the probability of readmission is shown as a function of time. Also, as shown in FIG. 2 or 6, an explanation of how the probability of readmission is determined is shown in the output. Additionally, a controlling line or other indicator may be shown to delineate a threshold level, such as a high readmission risk. The output shown in FIG. 6 also includes an area where the medical provider 214 can enter a message to the patient 212 that with be sent by e-mail or text message. While FIGS. 2 and 6 show two examples of outputs of the system 100, it is contemplated that any suitable output format may be employed without departing from the scope of the disclosed concept.

Referring back to FIG. 1, The SMS interface 104 is structured to exchange text messages with a mobile device 216, such as a mobile phone, of the patient 212. In more detail, the system 100 creates a survey of questions for the patient 212 and provides the survey to the patient's mobile device 216 via text messaging. The patient 212 then responds to the survey via text messaging. The patient's response to the survey is then used along with the other patient data and the adaptive readmission risk model to re-calculate the probability of readmission of the patient. Furthermore, the patient's response to the survey can be used to update the adaptive readmission risk model.

The questions used in the survey may be manually selected or created by the medical provider 214, or they may be automatically generated by the system 100. The questions used in the survey may also be selected specifically for the patient 212 based on, for example, the patient data and are generally relevant to the patient's condition.

Interacting with the patient 212 via text messaging makes it convenient for the patient 212 to respond to the survey. For instance, it is more convenient for the patient 212 to respond to a text message on a mobile device than it is for the patient to login to a website to complete a survey.

While the patient's mobile device 216 is shown, it is also contemplated that the medical provider 214 may also have a mobile device and that the SMS interface 104 may be structured to communicate with the medical provider's mobile device to, for example, provide updates, a probability of readmission of a patient, or other information to the medical provider 214.

FIG. 3 is a flowchart of a method for calculating the probability of readmission of a patient in accordance with an exemplary embodiment of the disclosed concept. It is contemplated that the method of FIG. 3 may be enacted by the system 100 of FIG. 1.

At operation 300, the system 100 receives patient data from various information sources such as electronic health records 200, clinical information systems 202, administrative information systems 204, the case management system 206, patient reported outcomes 208, and patient claims 210. The system 100 may also receive data from the patient 212 or medical provider 214.

At operation 302, the pre-processing module 106 performs pre-processing on at least a portion of the patient data. The pre-processing may include mapping hospital terms to standard concept codes, developing an ontology hierarchy between different clinical terms to summarize clinical information, and using natural language processing to extract clinical information from free-text data.

At operation 304, the probability of readmission is calculated by the system 100. The system uses the patient data and the adaptive readmission risk model to calculate the probability of readmission for the patient. The probability of readmission may be calculated as a function of time over a specified time period.

At operation 306, the patient data is incorporated into the adaptive readmission risk model. By continuing to use patient data to update and re-train the adaptive readmission risk model, the adaptive readmission risk model adapts with the patient data and thus can become more and more accurate over time. In addition to incorporating the patient data into the adaptive readmission risk model, medical provider 214 feedback may also be incorporated into the adaptive readmission risk model, which further increases its accuracy.

At operation 308, the probability of readmission is provided to the medical provider 214 in an output such as the screen shown in FIG. 2. The probability of readmission may also be provided to the patient 212 as well. An explanation for the probability of readmission, such as particular items of data that raised the probability of readmission, are also provided to the medical provider 214.

At operation 310, the medical provider 214 may provide feedback or corrections on the patient data. For example, if the medical provider 214 disagrees with an item of the patient data, the medical provider 214 may change it and initiate another calculation of the probability of readmission. Allowing medical provider feedback in addition to the automation of the system 100 provides more accurate results and therefore improves the functioning of the system 100 as an adaptive readmission prediction apparatus.

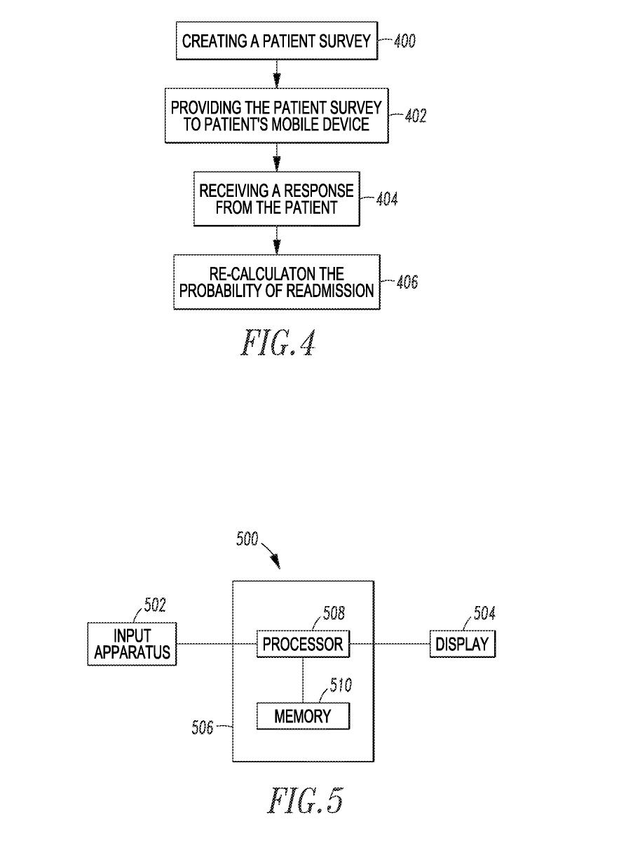

FIG. 4 is a flowchart of a method of surveying a patient in accordance with an exemplary embodiment of the disclosed concept. The method of FIG. 4 is employed in conjunction with the method of FIG. 3.

At operation 400, the system 100 creates a patient survey. The patient survey includes questions pertinent to the patient's readmission probability. The questions may be manually selected or created by the medical provider 214, or they may be automatically generated by the system 100. Some examples of questions are: Have you taken your medicine?; Have you experienced any weight gain?; Have you experienced any lower leg problems or pain?; Have you experienced any shortness of breath?; Have you noticed any ankle swelling?.

A graphical user interface (GUI) may be used by the medical provider 214 to create the patient survey. The GUI may have a drag and drop feature that allows the medical provider 214 to select a question in one area of the GUI and drag it to another area of the GUI and drop it to include it in the patient survey. The patient survey may be adaptive to the patient's answers. For example, if the answer to one question is “yes” the next question in the patient survey can be asked, whereas if the answer to the question is “no”, no more questions will be asked. It is contemplated that the GUI may be web-based and accessible over the interne.

At operation 402, the patient survey is provided to the patient's mobile device. The patient survey may be provided to the patient's mobile device via text messaging from system 100. It is contemplated that patient survey questions may be provided sequentially to patient and that the answer to a patient survey question may trigger related questions to be generated and provided to the patient.

At operation 404, the system 100 receives the response to the patient survey from the patient 212. Again, the system 100 may receive the response to the patient survey via text messaging through SMS interface 104. The patient's response may be processed by natural language processing and/or ontology hierarchy in the pre-processing module 106.

At operation 406, the probability of readmission is recalculated (FIG. 3). The probability of readmission may be provided to the medical provider 214 after recalculation.

It is contemplated that the method of FIG. 4 may be used in conjunction with the method of FIG. 3. For example, the method of FIG. 4 may be incorporated into operation 300 or appended after operation 308 in FIG. 3.

FIG. 5 is a block diagram of computing device 500 according to an exemplary embodiment of the disclosed concept. As seen in FIG. 5, the exemplary computing device 500 includes an input apparatus 502 (which in the illustrated embodiment is a keyboard), a display 504, and a processor apparatus 506. A user is able to provide input into processor apparatus 506 using input apparatus 502, and processor apparatus 506 provides output signals to display 504 to enable display 504 to display information to the user as described in detail herein. Processor apparatus 506 comprises a processor 508 and a memory 510. Processor 508 may be, for example and without limitation, a microprocessor (μP), microcontroller, or some other suitable processing device, that interfaces with memory 510. Memory 510 can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. Memory 510 has stored therein a number of routines that are executable by processor 508.

It is contemplated that system 100 may be implemented in computing device 500. It is also contemplated that the patient's mobile device 216 may be implemented in a device similar to computing device 500. It is further contemplated that the methods of FIGS. 3 and 4 may be implemented in computing device 500.

The disclosed concept can also be embodied as computer readable codes on a tangible, non-transitory computer readable recording medium. The computer readable recording medium is any data storage device that can store data which can be thereafter read by a computer system. Non-limiting examples of the computer readable recording medium include read-only memory (ROM), non-volatile random-access memory (RAM), CD-ROMs, magnetic tapes, floppy disks, disk storage devices, and optical data storage devices.

It is contemplated that the embodiments of the disclosed concept described herein will largely automate the process of calculating the probability of readmission of a patient, whereas the process has generally been performed manually in the past. Additionally, it is contemplated that the use of multiple information sources with pre-discharge and post-discharge patient data, as well as using an adaptive readmission risk model, will increase the accuracy of the probability calculation and improve the functionality of system 100.

The probability of readmission of the patient and the explanations for the probability of readmission can be used to determine treatments for the patient both during their hospital stay and after they are discharged, It is contemplated that the system 100 may generate treatment suggestions based on the probability of readmission and the explanation for the probability. In this manner, the probability that a patient will be readmitted can be reduced, and thus the hospital may avoid financial penalties.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method for determining a probability of readmission of a patient, the method comprising:
receiving patient data from a plurality of information sources;
calculating the probability of readmission of the patient based on the patient data and an adaptive readmission risk model; and
providing the probability of readmission of the patient to a medical provider.

2. The method of claim 1, further comprising:
creating a patient survey;
providing the patient survey to a mobile device of the patient;
receiving a response to the patient survey; and
re-calculating the probability of readmission of the patient based on the patient data, the adaptive readmission risk model, and the response to the patient survey.

3. The method of claim 2, wherein the patient survey is provided and received via text-messaging.

4. The method of claim 2, wherein the patient survey is specific to the patient.

5. The method of claim 1, further comprising:
receiving corrections and/or feedback from the medical provider; and
incorporating the corrections and/or feedback into the adaptive readmission risk model.

6. The method of claim 1, further comprising:
providing an explanation of the probability of readmission of the patient to the medical provider.

7. The method of claim 1, wherein the patient data includes pre-discharge patient data and post-discharge patient data.

8. The method of claim 1, further comprising:
pre-processing at least a portion of the patient data before calculating the probability of readmission of the patient, wherein the pre-processing includes at least one of:
a) mapping hospital terms to standard concept codes;
b) developing an ontology hierarchy between different clinical terms to summarize clinical information; and
c) using natural language processing to extract clinical information from free-text data.

9. The method of claim 1, further comprising:
incorporating at least a portion of the patient data into the adaptive readmission risk model.

10. A system for determining a probability of readmission of a patient, the system comprising:
an interface structured to receive patient data from a plurality of information sources; and
an adaptive modeling module structured to calculate the probability of readmission of the patient based on the patient data and an adaptive readmission risk model,
wherein the interface is further structured to provide the probability of readmission of the patient to a medical provider.

11. The system of claim 10, further comprising:
an SMS interface structured to provide a patient survey to a mobile device of the patient and receive a response to the patient survey,
wherein the adaptive modeling module is structured to re-calculate the probability of readmission of the patient based on the patient data, the adaptive readmission risk model, and the response to the patient survey.

12. The system of claim 11, wherein the patient survey is provided and received via text-messaging.

13. The method of claim 11, wherein the patient survey is specific to the patient.

14. The system of claim 10, wherein the interface is structured to receive corrections and/or feedback from the medical provider; and wherein the adaptive modeling module is structured to incorporate the corrections and/or feedback into the adaptive readmission risk model.

15. The system of claim 10, wherein the interface is structured to provide an explanation of the probability of readmission of the patient to the medical provider.

16. The system of claim 10, wherein the patient data includes pre-discharge patient data and post-discharge patient data.

17. The system of claim 10, further comprising:
a pre-processing module structured to pre-process at least a portion of the patient data before the adaptive modeling module calculates the probability of readmission of the patient, wherein the pre-processing includes at least one of:
a) mapping hospital terms to standard concept codes;
b) developing an ontology hierarchy between different clinical terms to summarize clinical information; and
c) using natural language processing to extract clinical information from free-text data.

18. The system of claim 10, wherein the adaptive modeling module is structured to incorporate at least a portion of the patient data into the adaptive readmission risk model.

19. A non-transitory computer readable medium storing one or more programs, including instructions, which when executed by a computer, causes the computer to perform a method of determining a probability of readmission of a patient, the method comprising:
receiving patient data from a plurality of information sources;
calculating the probability of readmission of the patient based on the patient data and an adaptive readmission risk model; and
providing the probability of readmission of the patient to a medical provider.

20. The non-transitory computer readable medium of claim 19, wherein the method further comprises:
creating a patient survey;
providing the patient survey to a mobile device of the patient;
receiving a response to the patient survey; and
re-calculating the probability of readmission of the patient based on the patient data, the adaptive readmission risk model, and the response to the patient survey.

21. The non-transitory computer readable medium of claim 20, wherein the patient survey is provided and received via text-messaging.

22. The non-transitory computer readable medium of claim 20, wherein the patient survey is specific to the patient.

23. The non-transitory computer readable medium of claim 19, wherein the method further comprises:
receiving corrections and/or feedback from the medical provider; and
incorporating the corrections and/or feedback into the adaptive readmission risk model.

24. The non-transitory computer readable medium of claim 19, wherein the method further comprises:
providing an explanation of the probability of readmission of the patient to the medical provider.

25. The non-transitory computer readable medium of claim 19, wherein the patient data includes pre-discharge patient data and post-discharge patient data.

26. The non-transitory computer readable medium of claim 19, wherein the method further comprises:
pre-processing at least a portion of the patient data before calculating the probability of readmission of the patient, wherein the pre-processing includes at least one of:
a) mapping hospital terms to standard concept codes;
b) developing an ontology hierarchy between different clinical terms to summarize clinical information; and
c) using natural language processing to extract clinical information from free-text data.

27. The non-transitory computer readable medium of claim 19, wherein the method further comprises:
incorporating at least a portion of the patient data. into the adaptive readmission risk model.
